(19) United States
(12) Patent Application Publication
(10) Pub. No.: US 2020/0090146 A1
(43) Pub. Date: Mar. 19, 2020

(54) VERIFICATION AND AUTHENTICATION OF OPTICAL MACHINE-READABLE CODES FOR PAYMENT PROCESSING

(71) Applicant: CA, Inc., New York, NY (US)

(72) Inventors: Vikrant Nandakumar, Bangalore (IN); Lyju Vadassery, Mumbai (IN); Vijay Shashikant Kulkarni, Bangalore (IN); Deepti Srikant Sharma, Bangalore (IN)

(73) Assignee: CA, Inc., New York, NY (US)

(21) Appl. No.: 16/133,934

(22) Filed: Sep. 18, 2018

(51) Int. Cl. G06Q 20/10; G06Q 20/40; G06Q 20/20; G06Q 20/32; G06K 19/06; H04W 4/12

(52) U.S. Cl. CPC G06Q 20/102; G06Q 20/401; G06Q 20/204; H04W 4/12; G06Q 20/325; G06K 19/06037; G06K 19/06112; G06Q 20/3276

(57) ABSTRACT

A merchant device receives a request message from a user terminal as part of a payment processing transaction with the merchant. The request message contains code data representing optical machine-readable code (OMRC) that has been read by the user terminal. The OMRC is representative of a payment processing account and allows the user terminal to complete the transaction with the merchant by directing the payment processor to transfer funds to the payment processing account associated with the OMRC. The merchant device determines, based on the code data, whether the payment processing account represented by the OMRC is an authorized payment processing account, and wirelessly transmits a response message to the user terminal indicative of whether the user terminal is permitted to use the payment processing account for the transaction.

### FIELD

Embodiments relate generally to electrical computers and digital processing systems, and more particularly, to communications with a merchant device for verification and authentication of optical machine-readable codes for payment processing.

### BACKGROUND

Transactions are increasingly being performed without use of credit cards, so called “cardless transactions.” The process of performing a cardless transaction can include a purchaser operating a user terminal to use a camera to scan a quick response (QR) code sticker that a merchant has displayed near the merchant's point of sale (POS) terminal. The QR code is supposed to uniquely identify the merchant. The user terminal reports the QR code to an authorization server. The POS terminal reports the transaction amount and a transaction number to the authorization server. The authorization server validates the transaction and initiates transfer of funds from a bank or credit account held by the purchaser's banking institution to a merchant's account that is identified based on the QR code.

A security weakness in this process is reliance on the QR code to identify the merchant's account. A fraudster can print a sticker having a QR code that identifies the fraudster's account and attach the sticker to cover the merchant's QR code. Purchasers then unknowingly scan the fraudster's QR code which causes funds to be transferred from the purchasers' accounts to the fraudster's account instead of to the merchant's account. Moreover, the merchant may observe via the purchasers' terminals displayed notifications that payments have been authorized but be unaware that the payments have been fraudulently misdirected to the fraudster's account.

### SUMMARY

Some embodiments described herein are directed a method including wirelessly receiving, by a merchant device comprising a processing device, a request message from a user terminal. The request message contains code data representing an optical machine-readable code that has been read by the user terminal, the optical machine-readable code representative of a payment processing account. The method further includes determining, by the merchant device based on the code data, whether the payment processing account represented by the optical machine-readable code is an authorized payment processing account. The method further includes wirelessly transmitting, by the merchant device based on the determining, a response message to the user terminal indicative of whether the user terminal is permitted to use the payment processing account for a transaction.

Some related embodiments described herein are directed to a method including reading, by a user terminal comprising a processing circuit, an optical machine-readable code representative of a payment processing account. The method further includes wirelessly transmitting, by the user terminal, an authorization request message containing code data representing the optical machine-readable code to a merchant device. The method further includes wirelessly receiving, by the user terminal, a response message from the merchant device. The response message contains response data representing a permission to use the payment processing account for a transaction. The method further includes determining, by the user terminal based on the response data, whether the user terminal has permission to transmit a transaction request message to a remote payment processing system via a network for authorizing a deposit of funds into the payment processing account.

Some related embodiments described herein are directed to a merchant device including a processing circuit, a wireless communication interface, and a memory coupled to the processing circuit. The memory includes machine-readable instructions that, when executed by the processing circuit, cause the processing circuit to wirelessly receive a request message from a user terminal via the wireless communication interface. The request message contains code data representing an optical machine-readable code that has been read by the user terminal, the optical machine-readable code representative of a payment processing account. The machine-readable instructions, when executed by the processing circuit, further cause the processing circuit to determine, based on the code data, whether the payment processing account represented by the optical machine-readable code is an authorized payment processing account. The machine-readable instructions, when executed by the processing circuit, further cause the processing circuit to wirelessly transmit, based on the determining, a response message to the user terminal via the communication interface indicative of whether the user terminal is permitted to use the payment processing account for a transaction.

Other apparatuses, methods, and computer program products according to embodiments will be or become apparent to one with skill in the art upon review of the following drawings and detailed description. It is intended that all such additional apparatuses, methods, and computer program products, including any and all combinations of operations performed thereby, be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram illustrating components of a computer system that includes a user terminal, a merchant terminal, and a transaction authorization server that are configured to operate in accordance with some embodiments;

FIGS. 2A and 2B are data flow diagrams of operations that are performed by a user terminal, the merchant terminal, and the transaction authorization server similar to the components of FIG. 1, in accordance with some embodiments;

FIGS. 3A-3C are a combined flow chart diagram of a method that may be performed by a user terminal, the merchant terminal, and the transaction authorization server similar to the components of FIG. 1, in accordance with some embodiments;

FIG. 4 is a block diagram of components of a user terminal similar to the user terminal of FIG. 1 in accordance with some embodiments;

FIG. 5 is a block diagram of components of a merchant terminal similar to the merchant terminal of FIG. 1 in accordance with some embodiments; and

FIG. 6 is a is a block diagram of components of a transaction authorization server similar to the transaction authorization server of FIG. 1 in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

Embodiments relate generally to electrical computers and digital processing systems, and more particularly, to communications with a merchant device for verification and authentication of optical machine-readable codes (OMRCs) for payment processing. In some embodiments, a merchant device receives a request message from a user terminal, such as a mobile phone or other customer device, as part of a payment processing transaction with the merchant. The request message contains code data representing an OMRC, e.g., a QR code or other type of bar code, that has been read by the user terminal. The OMRC is representative of a payment processing account and allows the user terminal to complete the transaction with the merchant by directing the payment processor to transfer funds to the payment processing account associated with the OMRC. The merchant terminal determines, based on the code data, whether the payment processing account represented by the OMRC is an authorized payment processing account, e.g., is the correct account for transferring funds to the merchant, and wirelessly transmits a response message to the user terminal indicative of whether the user terminal is permitted to use the payment processing account for the transaction.

One advantage of this arrangement is that the merchant terminal does not need to communicate with the payment processor directly or be otherwise connected to a network. Instead, the merchant terminal can locally verify that an OMRC is genuine and provide the user terminal with permission to proceed. The user terminal is then able to complete the transaction with the payment processor directly. This allows the merchant terminal to be an inexpensive standalone device can provide an added layer of security for OMRC-based payments without requiring the merchant to maintain an expensive networked point-of-sale system.

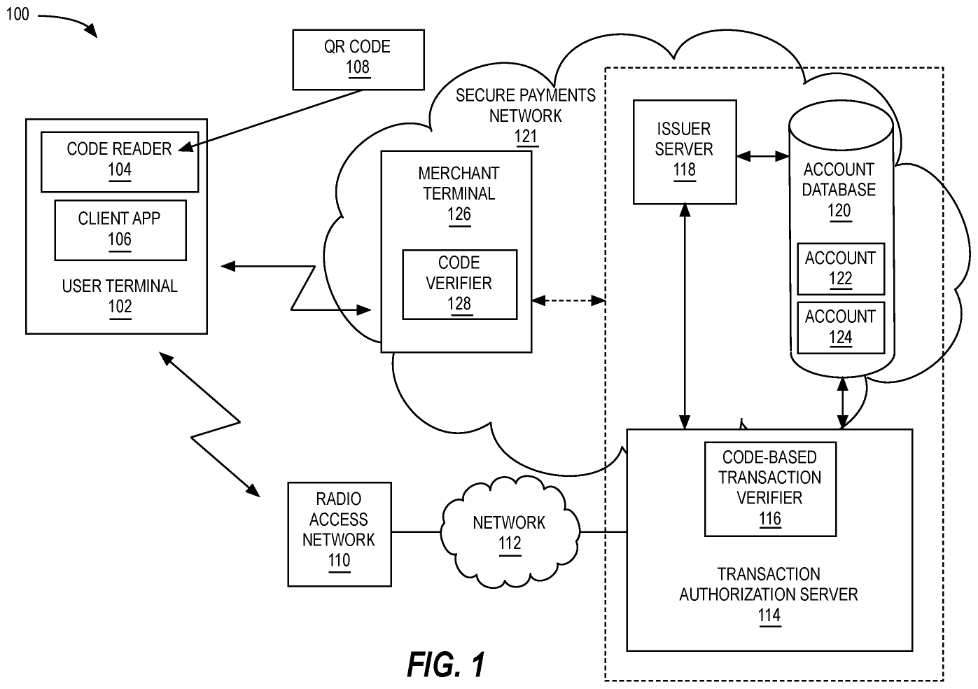

Example operations that can performed for these and other embodiments will be described in example environment of a computer system shown in FIG. 1. FIG. 1 is a block diagram illustrating components of a computer system 100 that includes a user terminal 102, a merchant terminal 126, and a transaction authorization server 114 that are configured to operate in accordance with some embodiments. Referring to FIG. 1, the user terminal includes an optical code reader 104, such as a camera or laser scanner for example, that is operable to read an OMRC 108.

The user terminal 102 may also include a client application 106 (e.g., a mobile payments application) or other software installed thereon that is operated by a user to perform transactions (e.g., debit, credit, or other portable card) with a payment processor. As part of the transaction, the user terminal 102 may communicate, via a radio access network 110 and network 112, for example, with the transaction authorization server 114. The transaction authorization server 114 includes a code-based transaction verifier 116 that communicates with an issuer server 118, some or all of which are communicatively coupled to payment nodes that define a secure payments network 121 having network nodes that route communications between these components. The secure payments network 121 can include a private network and/or may include components of a public network, e.g., Internet, with secure encryption providing secure communication pipelines therethrough. Network nodes of the secure payments network 121 may be interconnected by a secure wide area network (WAN), local area network (LAN), Intranet, and/or other private network, which may not be accessible by the nodes of the network 112.

In some embodiments, the transaction authorization server 114 may be a third-party server that is communicatively coupled to the issuer server 118 and is configured to perform various functions on behalf of the issuer server 118. The issuer server 118 and transaction authorization server 114 may be implemented as a single server, separate servers, or a network of servers (physical and/or virtual), which may be co-located in a server farm or located in different geographic regions. The issuer server 118 is connected to an account database 120 containing information for a plurality of accounts 122, 124, etc. The plurality of accounts 122, 124 may include a user account with associated user account information, e.g., credit card account information for cardholders and may operate to retrievably store credit card account balances and contact information for credit card holders responsive to messages from the issuer server 118.

At least one of the issuer server 118 and the transaction authorization server 114 is communicatively coupled, via one or more network nodes that are outside of the secure payments network 121, to a user terminal 102 that is operated by a user (e.g., credit card account holder, debit account holder, etc.) associated with an account managed by the issuer server 118 (e.g., credit card account, debit account, etc.). The user terminal 102 may be any wireless mobile consumer electronic device that is configured to transmit and receive data or communications to and from the servers 114 and/or 118 via the radio access network 110, for example. It will be appreciated that, in various embodiments described herein, the user terminal 102 may be a mobile phone (e.g., smart phone, cellular phone, etc.), tablet, portable media player, laptop computer, desktop computer, personal digital assistant (PDA), and/or wearable computing device (e.g., watch), or other consumer electronic device. The radio access network 110 can include, but is not limited to, cellular radio access transceiver base stations (e.g., 3GPP 3G, 3G, 4G, NR cellular protocols) and/or Wi-Fi radio access points.

As described herein, a computer server (“server” for brevity) may include a computer or cluster of computers. For example, the computer server can be a large mainframe, a minicomputer cluster, or a group of servers functioning as a unit. In one example, the computer server may be coupled to a Web server. The computer server may be coupled to a database and may include hardware (including one or more processors, memory, etc.), software, or combinations thereof for servicing the requests from one or more client computers. The computer server may include one or more computational apparatuses and may use any of a variety of computing structures, arrangements, and compilations for servicing the requests from one or more client computers.

An issuer may refer to a business entity (e.g., a bank) that maintains an account (e.g., a monetary account, such as a bank account, credit payment account, etc.) for a user (also referred to herein as an account holder). The account may be associated with a user terminal, such as the user terminal 102. An issuer is associated with an issuer server 118 that performs some or all of the functions of the issuer. For example, an issuer may store and/or define account parameters via the issuer server 118 associated with the account for use by the user terminal 102 and the account holder.

As part of the transaction, funds are transferred from a first account 122, e.g., a customer's account associated with the client application 106 of the user terminal 102, to a second account 124, e.g., an account associated with the OMRC 108. During a transaction with a merchant, the OMRC 108 is displayed by a merchant and is associated with one of the accounts 122, 124 in the account database 120 of the secure payments network 121. As used herein, a merchant may refer to an entity that engages in electronic transactions for goods or services. The user terminal 102 reads the OMRC 108 and completes the transaction via the transaction authorization server 114 without the need for the merchant to maintain a separate point of sale terminal or otherwise communicating with the transaction authorization server 114.

One security weakness in this process is reliance on an OMRC 108 to identify the merchant's account. A fraudster can print a sticker having a code that identifies the fraudster's account and attach the sticker to cover the merchant's code. Purchasers then unknowingly scan the fraudster's code which causes funds to be transferred from the purchasers' accounts to the fraudster's account instead of to the merchant's account. While the merchant may observe via the purchasers' terminal's displayed notifications that payments have been authorized, the fraudster may also associate a name with the fraudulent account that is the same or similar to the name on the merchant's account, thereby deceiving the merchant into believing that the payments have been directed to the correct account when the payments have been fraudulently misdirected to the fraudster's account.

Another security weakness in this process is that a fraudster can produce a fraudulent code and surreptitiously read the fraudulent code during a transaction in a way that deceives the merchant into believing that the code displayed at the point of sale has been read. When the merchant observes the purchasers' terminal's displayed notifications that payments have been authorized, the fraudster is actually transferring funds into his own account rather than paying the merchant for the goods and services involved in the transaction.

To combat these and other security weaknesses, a merchant terminal 126 may be provided that includes a code verifier 128 module, which may be based in hardware and/or software. In many embodiments, the merchant terminal 126 may be an inexpensive, standalone device that does not need to communicate with the transaction authorization server 114. In other embodiments, it may be desirable for the merchant terminal 126 to be able to communicate with the transaction authorization server 114 or other components of the secure payments network 121. In this regard, the merchant terminal 126 may refer to a standalone computing device, a point-of-sale (POS) terminal, a point-of-banking (POB) terminal, an automated teller machine (ATM) terminal, and/or other terminal that is associated with the merchant and is operable to conduct a monetary transaction with a user/consumer account, for example.

In one illustrative embodiment, a user (e.g., buyer) can make a payment using a client application 106 executed by the user terminal 102 by scanning the merchant's displayed OMRC 108. The merchant may display the OMRC 108 in a number of ways. In some embodiments, the merchant may display a printed OMRC 108, such as a sticker or a sign, proximate to the point of sale. Alternatively, the merchant terminal 126 or another device may display the OMRC 108 on a display device, which may be synchronized with the transaction authorization server 114. For example, the OMRC 108 may be generated by the transaction authorization server 114 or by the merchant terminal 126 or another device, based on a combination of the transaction reference number for the transaction and a transaction time (e.g., present time of day of the transaction). The OMRC 108 may be further generated based on a geographic location of the merchant terminal 126. Regardless of how the OMRC 108 is generated or displayed, however, the merchant terminal 126 functions as an additional failsafe to verify that the correct OMRC 108 has been read by the user terminal 102 during a transaction.

During the transaction, an optical code reader 104 (e.g., camera or laser scanner with OMRC scanning software) of the user terminal 102 is operated to scan the OMRC 108 using the client application 106. The scanned OMRC 108 is decoded to obtain OMRC information. Before the OMRC information is sent to the transaction authorization server 114, however, the user terminal 102 first generates and wirelessly transmits a request message containing code data representing the OMRC 108, such as the OMRC information. The user terminal 102 may wirelessly transmit the request message via any number of wireless communication operational protocols, such as an ultrasonic operational protocol, a radio frequency (RF) operational protocol, or an infrared (IR) operational protocol, for example.

The code verifier 128 of the merchant terminal 126 determines, based on the code data, whether the payment processing account represented by the OMRC 108 is an authorized payment processing account. For example, the code verifier 128 may determine whether the OMRC 108 is a genuine OMRC associated with the merchant's account or whether the OMRC 108 is a fraudulent OMRC associated with an unauthorized account.

Based on the determination, the merchant terminal 126 generates and wirelessly transmits a response message to the user terminal 102 indicative of whether the user terminal 102 is permitted to use the payment processing account for a transaction. If the merchant terminal 126 determines that the account associated with OMRC 108 to be an authorized payment processing account, the response message is configured by the merchant terminal 126 to indicate permission for the user terminal 102 to use the authorized payment processing account for the transaction. Conversely, if the merchant terminal 126 determines that the account associated with OMRC 108 to not be an authorized payment processing account, the response message is configured by the merchant terminal 126 to indicate denial of permission for the user terminal 102 to use the unauthorized payment processing account, i.e., the payment processing account represented by the OMRC 108, for the transaction.

In some embodiments, if the merchant terminal 126 determines that the account associated with OMRC 108 to not be an authorized payment processing account, the merchant terminal 126 may perform additional functions. For example, the merchant terminal 126 and/or user terminal 102 may transmit a notification message to the transaction authorization server 114, and/or other components of the system 100 containing an identifier of the user terminal 102 and an indication of an attempt by the user terminal 102 to use a payment processing account different from the authorized payment processing account for the transaction. The merchant terminal 126 and/or user terminal 102 may also cause a visual indication to be displayed indicating that the user terminal 102 has attempted to use an unauthorized payment processing account. The visual indication can be displayed to the merchant via a display device of the merchant terminal 126 or another device, and/or to the customer via a display device of the user terminal 102 or another device, for example. The merchant terminal 126, user terminal 102, or other device may also trigger generation an audio indication to alert the merchant, the customer, or others that the user terminal 102 has not provided an authorized payment processing account.

If the user terminal 102 is determined to have permission to transmit the transaction request message, the user terminal may display a selectable interface element for initiating payment. In response to receiving an input via a user interface of the user terminal 102, the user terminal may indicate that the user has selected the selectable interface element transmit a transaction request message to a the transaction authorization server 114 or another component of the secure payment network 121 via the network 112. The transaction request message contains authorization data, which may include the OMRC data, representing an authorization for transaction authorization server 114 or another component of the secure payment network 121 to deposit the funds into the authorized payment processing account, e.g., by transferring the funds from the a customer's account associated with the user terminal 102 to the merchant's authorized account.

As used herein, an OMRC can be any optical code that can be scanned by a user terminal, and can include, but is not limited to, a QR code or other matrix barcode, two-dimensional optical code, or other multidimensional optical code. The OMRC may alternatively be a one-dimensional code, such as a universal product code (UPC) or other barcode. For ease of explanation and understanding, the detailed description and figures refers to the use of QR codes and information in some embodiments. However, it is to be understood that embodiments herein are not limited to QR codes and maybe more generally used with any type of OMRC. Accordingly, each reference to a QR code herein may be replaced with OMRC, as desired.

In some embodiments, the user terminal 102 operates the optical code reader 104 to scan the OMRC 108, which may be displayed by the merchant proximate to the merchant terminal 126. The user terminal 102 decodes the OMRC 108 to obtain decoded OMRC information and generates an OMRC request message based on the decoded OMRC information. In this example, the OMRC request message includes the decoded OMRC information. The user terminal transmits the OMRC request to the merchant terminal 136.

The merchant terminal 126 receives the OMRC request message containing the decoded OMRC information. The merchant terminal 126 attempts to match the decoded OMRC information to the OMRC information that is stored in the merchant terminal 126 with the association to the merchant identifier. In some embodiments, the OMRC information may be hard-wired into a component of the merchant terminal 126 to provide added security, or the OMRC information may be stored by the merchant terminal 126 in software. The merchant terminal 126 selectively validates the decoded OMRC information based on whether a match is identified and provides an OMRC response message indicating whether the OMRC 108 is valid. If the OMRC 108 is valid, the OMRC response message may contain the decoded OMRC information, an indication that the decoded OMRC information is valid, the transaction amount, and/or the merchant identifier. On the other hand, if the OMRC 108 is not valid, the OMRC response message may only contain an indication that the decoded OMRC information is not valid, and may omit the transaction amount, the merchant identifier and/or an indication of the authentic OMRC.

The user terminal 102 processes the OMRC response message sent by the merchant terminal 126. If the user terminal 102 determines that the OMRC response message contains an indication that the decoded OMRC information is valid and further contains a transaction amount and a merchant identifier, the user terminal 102 performs operations to display, on a display device, the transaction amount, the merchant identifier, and a query for a user to authorize the transaction. Responsive to the user terminal 102 receiving through a user input interface a user response authorizing the transaction, user terminal 102 transmits a transaction request message toward the transaction authorization server 114 containing an indication that the transaction is authorized.

On the other hand, if the user terminal 102 processes the OMRC validation message and determines that the OMRC validation message contains an indication that the decoded OMRC information is invalid, the user terminal 102 can display on the display device a notification indicating that the OMRC 108 is invalid and responsively deny the transaction by preventing communication of a transaction request message to the transaction authorization server 114 that would initiate transfer of funds.

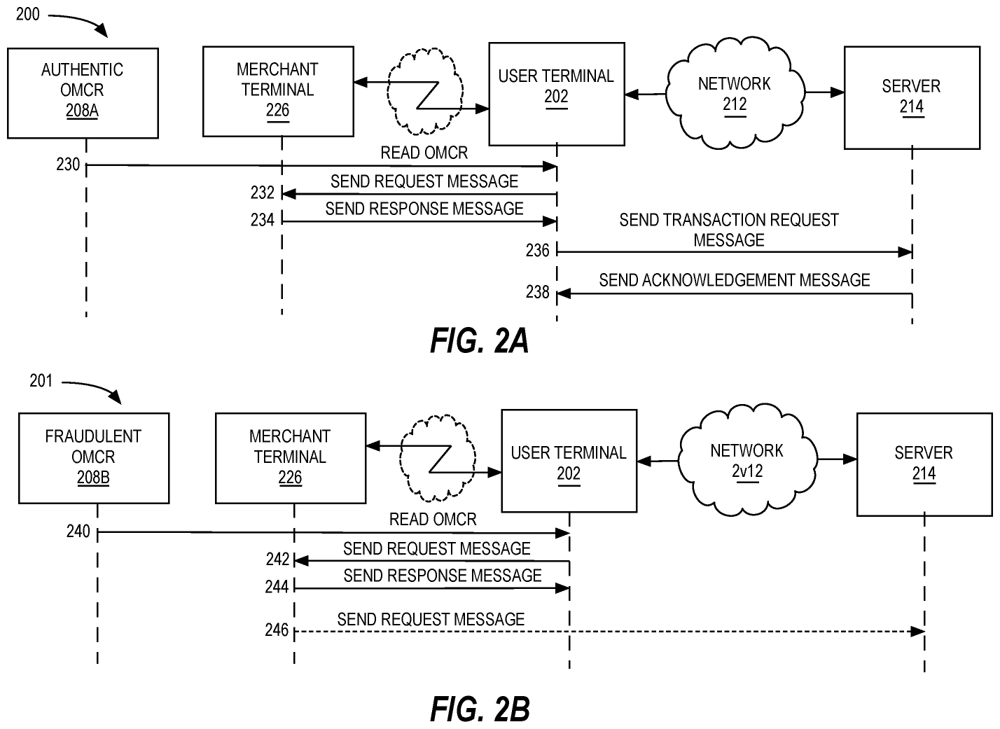

FIGS. 2A and 2B illustrate data flow diagrams of operations that are performed by a user terminal, the merchant terminal, and the transaction authorization server similar to the components of FIG. 1, in accordance with some embodiments. In particular, FIG. 2A is a data flow diagram 200A illustrating data flows for a scenario in which an authentic OMRC 208A is read by a user terminal 202, and FIG. 2B is a data flow diagram 200B illustrating data flows for a scenario in which a fraudulent OMRC 208B is read by the user terminal 202.

Referring now to FIG. 2A, an authentic OMRC 208A is read by the user terminal 202 (Operation 230), and the user terminal 202 sends a request message to the merchant terminal 226 that is configured to verify the OMRC 208A, via an appropriate operational protocol, e.g., ultrasound, RF, IR, etc. (Operation 232). The merchant terminal 226 sends a response message to the user terminal 202 indicating that the OMRC 208A is authentic (Operation 234), which allows the user terminal to send a transaction request message to the transaction authorization server 214 via the network 212 (Operation 236). The transaction authorization server 214 executes the transfer of funds and send an acknowledgement message to the user terminal (Operation 238).

In FIG. 2B, on the other hand, a fraudulent OMRC 208B is read by the user terminal 202 (Operation 240), and the user terminal 202 sends a request message to the merchant terminal 226 that is configured to verify the authentic OMRC 208A of FIG. 2A, via an appropriate operational protocol. (Operation 242). Here, however, the merchant terminal 226 sends a response message to the user terminal 202 indicating that the OMRC 208B is fraudulent (Operation 244), which prevents the user terminal 202 from proceeding with the transaction and optionally triggers the user terminal 202 to transmit an alert message to the transaction authorization server 214 or other device indicating an attempt to use a fraudulent OMRC 208B (Operation 246).

Although the communications are illustrated in FIGS. 2A and 2B as being performed directly between the user terminal 202, merchant terminal 226 in the transaction authorization server 214, intervening system nodes would typically be present, such as including the nodes shown and described with respect to FIG. 1. For example, the transaction request message and/or other messages can be received from or sent by the issuer server 118 of FIG. 1.

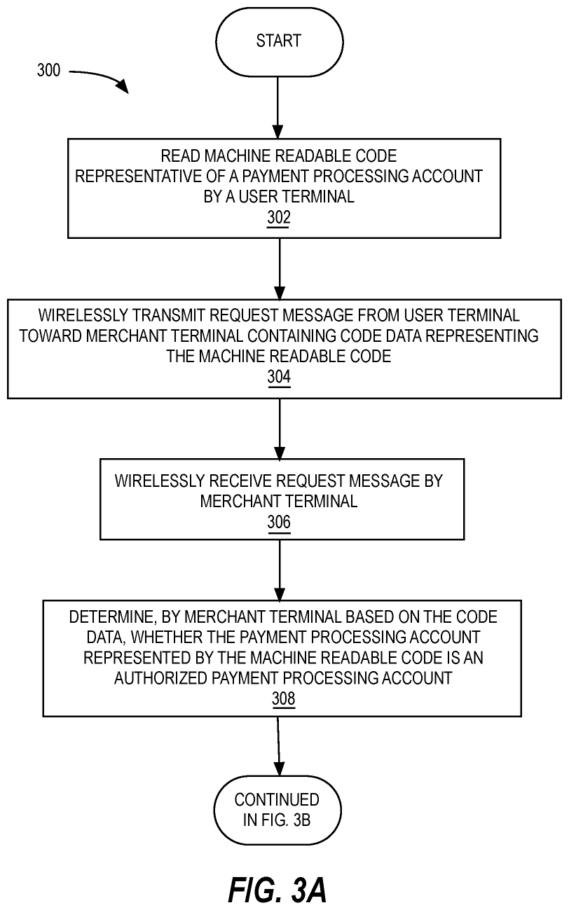

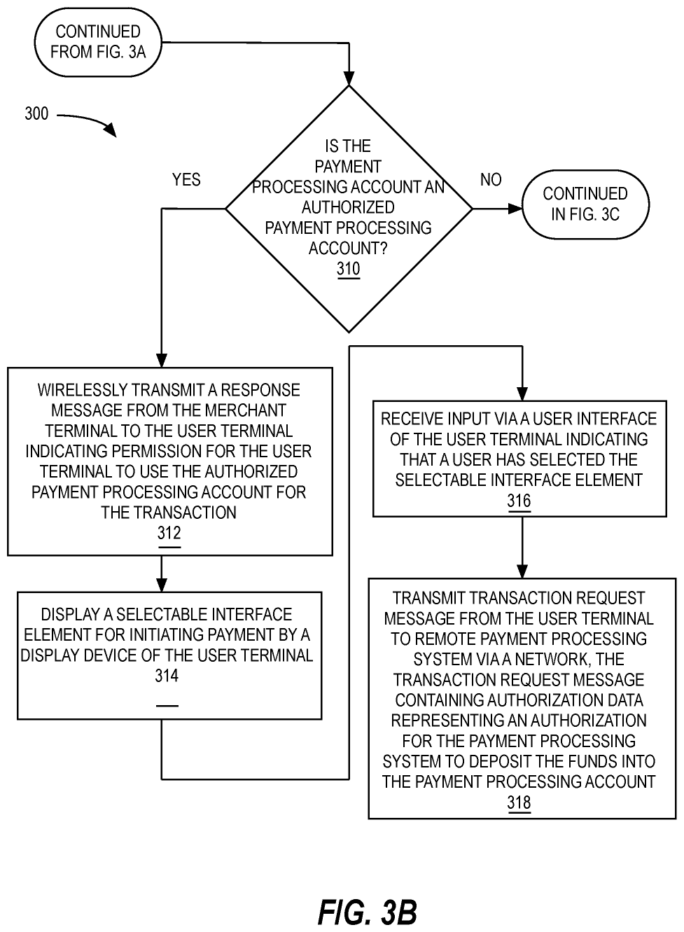

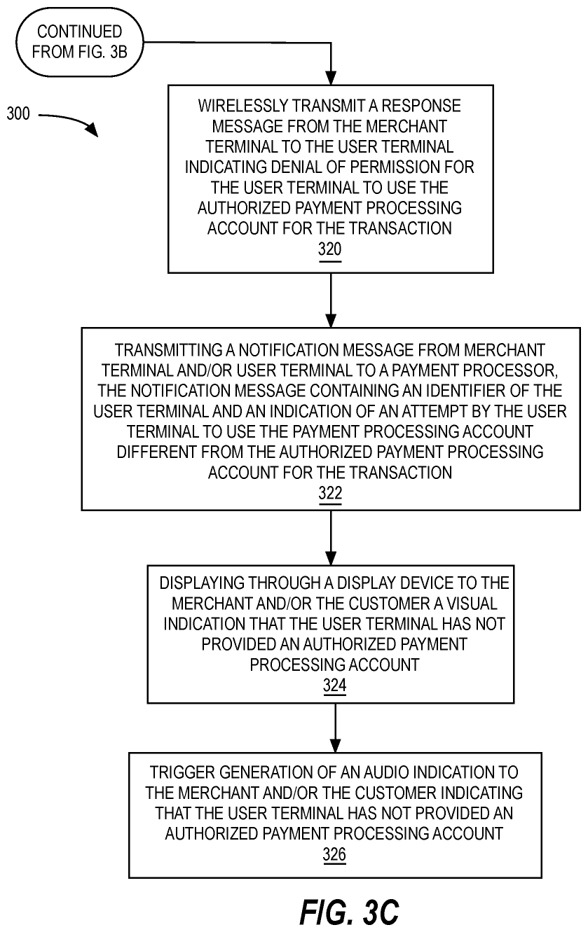

FIGS. 3A-3C are a combined flow chart diagram of a method 300 that may be performed by a user terminal, the merchant terminal, and the transaction authorization server similar to the components of FIG. 1, in accordance with some embodiments. Referring now to FIG. 3A, the method 300 includes reading an optical machine-readable code representative of a payment processing account by a user terminal (Block 302), such as the user terminal 102 of FIG. 1. The method 300 further includes wirelessly transmitting a request message containing code data representing the optical machine-readable code from the user terminal toward a merchant terminal (Block 304), such as the merchant terminal 126 of FIG. 1. The method 300 further includes wirelessly receiving the request message by the merchant terminal (Block 306), and determining, by the merchant terminal based on the code data, whether the payment processing account represented by the optical machine-readable code is an authorized payment processing account (Block 308).

Referring now to FIG. 3B, the method 300 may include different operations depending on whether the payment processing account is an authorized payment processing account (Block 310). If the payment processing account is an authorized payment processing account, the method 300 includes wirelessly transmitting a response message from the merchant terminal to the user terminal to use the authorized payment processing account for the transaction (Block 312). The method 300 further includes displaying a selectable interface element for initiating payment by a display device of the user terminal (Block 314), and receiving an input via a user interface of the user terminal indicating that a user has selected the selectable interface element (Block 316). The method 300 further includes transmitting a transaction request message form the user terminal to a remote payment processing system, such as the transaction authorization server 114 of FIG. 1, via a network, wherein the transaction request message contains authorization data representing an authorization for the payment processing system to deposit the funds into the payment processing account (Block 318).

Referring now to FIG. 3C, if the payment processing account is not an authorized payment processing account, the method 300 further includes wirelessly transmitting a response message from the merchant terminal to the user terminal indicating denial of permission for the user terminal to sue the authorized payment processing account for the transaction (Block 320). The method 300 further includes transmitting a notification message from the merchant terminal and/or the user terminal to a payment processor, wherein the notification message contains an identifier of the user terminal and an indication of an attempt by the user terminal to use an unauthorized payment processing account for the transaction (Block 322). The method 300 further includes displaying through a display device to the merchant and/or the customer a visual indication that the user terminal has attempted to use an unauthorized payment processing account for the transaction (Block 324), and triggering generation of an audio indication to the merchant and/or the customer indicating that the user terminal has attempted to use an unauthorized payment processing account for the transaction (Block 326). It should be understood that the method 300 may be modified to add processes, omit processes, or alter processes, as desired.

### Example User Terminal, Merchant Terminal, and Transaction Authorization Server

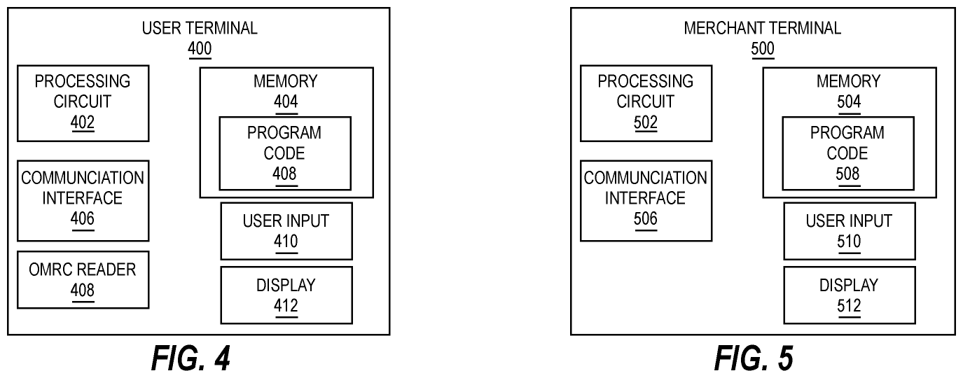

FIG. 4 is a block diagram of components of a user terminal 400 similar to the user terminal 102 of FIG. 1 in accordance with some embodiments. Referring to FIG. 4, the user terminal 400 includes a processing circuit 402, a memory 404, a communication interface 406, and an OMRC (e.g., QR code) reader 408 (e.g., camera and OMRC decoder software). The communication interface 406 may operate using an ultrasonic operational protocol, a radio frequency (RF) operational protocol, or an infrared (IR) operational protocol to communicate with a merchant terminal, such as the merchant terminals 126, 500 of FIGS. 1 and 5. The communication interface 406 can also include, but is not limited to, an LTE or other cellular transceiver, WLAN transceiver (IEEE 802.11), or other radio communication transceiver configured to communicate with a radio access network, such as the radio access network 110 of FIG. 1.

The processing circuit 402 may include one or more data processing circuits, such as a general purpose and/or special purpose processor (e.g., microprocessor and/or digital signal processor) that may be collocated or distributed across one or more networks. The processing circuit 402 is configured to execute computer program code 410, e.g. client application 106 of FIG. 1, in the memory 404, described below as a non-transitory computer readable medium, to perform at least some of the operations described herein as being performed by an access control computer. The computer program code when executed by the processing circuit 402 causes the processing circuit 402 to perform operations in accordance with one or more embodiments disclosed herein for the user terminal 400. The user terminal 400 may further include a user input interface 410 (e.g., touch screen, keyboard, keypad, etc.) and a display device 412.

FIG. 5 is a block diagram of components of a merchant terminal 500 similar to the merchant terminal 126 of FIG. 1 in accordance with some embodiments. Merchant terminal 500 includes a processing circuit 502, a memory 504, and a communication interface 506, which may operate using an ultrasonic operational protocol, a radio frequency (RF) operational protocol, or an infrared (IR) operational protocol to communicate with a user terminal, such as the user terminals 102, 400 of FIGS. 1 and 4. The communication interface 506 may optionally also be configured to communicate with the transaction authorization server 114 through the secure payments network 121 of FIG. 1.

The processing circuit 502 may include one or more data processing circuits, such as a general purpose and/or special purpose processor (e.g., microprocessor and/or digital signal processor) that may be collocated or distributed across one or more networks. The processing circuit 502 is configured to execute computer program code 508, e.g., the code verifier 128 of FIG. 1, in the memory 504, described below as a non-transitory computer readable medium, to perform at least some of the operations described herein as being performed by a merchant terminal. The computer program code when executed by the processing circuit 502 causes the processing circuit 502 to perform operations in accordance with one or more embodiments disclosed herein for the merchant terminal 500. The merchant terminal 500 may further include a user input interface 510 (e.g., touch screen, keyboard, keypad, etc.) and display device 512 for displaying the QR code or other OMRC.

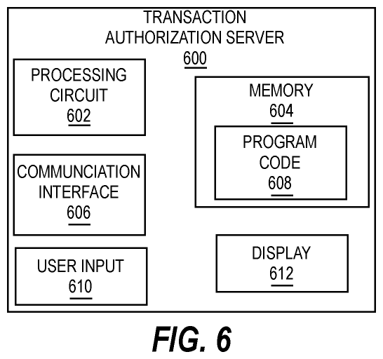

FIG. 6 is a is a block diagram of components of a transaction authorization server 600 similar to the transaction authorization server 114 of FIG. 1 in accordance with some embodiments. The transaction authorization server 600 includes a processing circuit 602, a memory 604, and a network interface 606 which can include, but is not limited to, a wired network interface (e.g., Ethernet) or wireless interface configured to communicate with the user terminal, such as the user terminals 102, 400 of FIGS. 1 and 4, e.g., via the radio access network 110 and the data network 112 of FIG. 1.

The processing circuit 602 may include one or more data processing circuits, such as a general purpose and/or special purpose processor (e.g., microprocessor and/or digital signal processor) that may be collocated or distributed across one or more networks. The processing circuit 602 is configured to execute computer program code 608, e.g., the code-based transaction verifier 116 of FIG. 1, in the memory 604, described below as a non-transitory computer readable medium, to perform at least some of the operations described herein as being performed by an access control computer. The computer program code when executed by the processing circuit 602 causes the processing circuit 602 to perform operations in accordance with one or more embodiments disclosed herein for the transaction authorization server 600. The transaction authorization server 600 may further include a user input interface 610 (e.g., touch screen, keyboard, keypad, etc.) and a display device 612.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
wirelessly receiving, by a merchant device comprising a processing device, a request message from a user terminal, the request message containing code data representing an optical machine-readable code that has been read by the user terminal, the optical machine-readable code representative of a payment processing account;
determining, by the merchant device based on the code data, whether the payment processing account represented by the optical machine-readable code is an authorized payment processing account; and
wirelessly transmitting, by the merchant device based on the determining, a response message to the user terminal indicative of whether the user terminal is permitted to use the payment processing account for a transaction.

2. The method of claim 1, responsive to the payment processing account represented by the optical machine-readable code being determined to be an authorized payment processing account, configuring the response message to indicate permission for the user terminal to use the authorized payment processing account for the transaction.

3. The method of claim 1, responsive to the payment processing account represented by the optical machine-readable code being determined to not be an authorized payment processing account, configuring the response message to indicate denial of permission for the user terminal to use the payment processing account represented by the optical machine-readable code for the transaction.

4. The method of claim 3, further comprising:
responsive to the payment processing account represented by the optical machine-readable code being determined to not be an authorized payment processing account, transmitting, by the merchant device, a notification message to a payment processor containing an identifier of the user terminal and an indication that the user terminal has attempted to use an unauthorized payment processing account.

5. The method of claim 3, further comprising:
responsive to the payment processing account represented by the optical machine-readable code being determined to not be an authorized payment processing account, displaying through a display device to a merchant a visual indication that the user terminal has attempted to use an unauthorized payment processing account.

6. The method of claim 3, further comprising:
responsive to the payment processing account represented by the optical machine-readable code being determined to not be an authorized payment processing account, triggering generation of an audio indication to a merchant indicating that the user terminal has attempted to use an unauthorized payment processing account.

7. The method of claim 1, wherein wirelessly receiving the request message and wirelessly transmitting the response message is performed using a wireless communication operational protocol comprising: an ultrasonic operational protocol, a radio frequency (RF) operational protocol, or an infrared (IR) operational protocol.

8. A method comprising:
reading, by a user terminal comprising a processing circuit, an optical machine-readable code representative of a payment processing account;
wirelessly transmitting, by the user terminal, an authorization request message containing code data representing the optical machine-readable code to a merchant device;
wirelessly receiving, by the user terminal, a response message from the merchant device, the response message containing response data representing a permission to use the payment processing account for a transaction; and
determining, by the user terminal based on the response data, whether the user terminal has permission to transmit a transaction request message to a remote payment processing system via a network for authorizing a deposit of funds into the payment processing account.

9. The method of claim 8, further comprising:
responsive to the user terminal being determined to have permission to transmit the transaction request message, transmitting the transaction request message to a remote payment processing system via a network, the transaction request message containing authorization data representing an authorization for the remote payment processing system to deposit the funds into the payment processing account.

10. The method of claim 9, further comprising, prior to initiating payment:
responsive to the user terminal being determined to have permission to transmit the transaction request message, displaying a selectable interface element for initiating payment by a display device of the user terminal;
receiving an input via a user interface of the user terminal indicating that a user has selected the selectable interface element; and
responsive to receiving the input, transmitting, by the user terminal, the transaction request message to a remote payment processing system via a network, the transaction request message containing authorization data representing an authorization for the remote payment processing system to deposit the funds into the payment processing account.

11. The method of claim 8, further comprising:
responsive to the payment processing account represented by the optical machine-readable code being determined to not be an authorized payment processing account, transmitting, by the user terminal, a notification message to a payment processor containing an identifier of the user terminal and an indication of an attempt by the user terminal to use the payment processing account different from the authorized payment processing account for the transaction.

12. The method of claim 8, further comprising:
responsive to the payment processing account represented by the optical machine-readable code being determined to not be an authorized payment processing account, displaying, through a display device of the user terminal, a visual indication that the user terminal has attempted to use an unauthorized payment processing account.

13. The method of claim 8, further comprising:
responsive to the payment processing account represented by the optical machine-readable code being determined to not be an authorized payment processing account, trigger generation of an audio indication by the user terminal indicating that the user terminal has attempted to use an unauthorized payment processing account.

14. The method of claim 8, wherein wirelessly transmitting the authorization request message and wirelessly receiving the response message is performed using a wireless communication operational protocol comprising: an ultrasonic operational protocol, a radio frequency (RF) operational protocol, or an infrared (IR) operational protocol.

15. A merchant device comprising:
a processing circuit;
a wireless communication interface; and
a memory coupled to the processing circuit, the memory comprising machine-readable instructions that, when executed by the processing circuit:
cause the processing circuit to wirelessly receive a request message from a user terminal via the wireless communication interface, the request message containing code data representing an optical machine-readable code that has been read by the user terminal, the optical machine-readable code representative of a payment processing account;
cause the processing circuit to determine, based on the code data, whether the payment processing account represented by the optical machine-readable code is an authorized payment processing account; and
cause the processing circuit to wirelessly transmit, based on the determining, a response message to the user terminal via the wireless communication interface indicative of whether the user terminal is permitted to use the payment processing account for a transaction.

16. The merchant device of claim 15, the memory further comprising machine-readable instructions that, responsive to the payment processing account represented by the optical machine-readable code being determined to be an authorized payment processing account, cause the processing circuit to configure the response message to indicate permission for the user terminal to use the authorized payment processing account for the transaction.

17. The merchant device of claim 15, the memory further comprising machine-readable instructions that, responsive to the payment processing account represented by the optical machine-readable code being determined to not be an authorized payment processing account, cause the processing circuit to configure the response message to indicate denial of permission for the user terminal to use the payment processing account represented by the optical machine-readable code for the transaction.

18. The merchant device of claim 17, the memory further comprising machine-readable instructions that, responsive to the payment processing account represented by the optical machine-readable code being determined to not be an authorized payment processing account, causing the merchant device to transmit a notification message to a payment processor containing an identifier of the user terminal and an indication that the user terminal has attempted to use an unauthorized payment processing account.

19. The merchant device of claim 17, the memory further comprising machine-readable instructions that, responsive to the payment processing account represented by the optical machine-readable code being determined to not be an authorized payment processing account, cause the processing circuit to display a visual indication to a merchant through a display device to a merchant, the visual indication indicating that the user terminal has attempted to use an unauthorized payment processing account.

20. The merchant device of claim 15, wherein the wireless communication interface comprises: an ultrasonic operational interface, a radio frequency (RF) operational interface, or an infrared (IR) operational interface.
